(19) United States
(12) Patent Application Publication
(10) Pub. No.: US 2013/0108409 A1
(43) Pub. Date: May 2, 2013

(54) THIN SUBSTRATE, MASS-TRANSFER BERNOULLI END-EFFECTOR

(71) Applicants: Kung Chris Wu, Cupertino, CA (US); Jing Wen, Shenyang (CN); Ruiqiu Yang, Shenyang (CN); Junqiang Zheng, Shenyang (CN)

(72) Inventors: Kung Chris Wu, Cupertino, CA (US); Jing Wen, Shenyang (CN); Ruiqiu Yang, Shenyang (CN); Junqiang Zheng, Shenyang (CN)

(21) Appl. No.: 13/807,920

(22) PCT Filed: Jul. 5, 2011
(86) PCT No.: PCT/US2011/001177

§ 371 Date: Dec. 31, 2012

Related U.S. Application Data
(60) Provisional application No. 61/398,979, filed on Jul. 2, 2010.

(51) Int. Cl. B25J 15/06

(52) U.S. Cl. CPC B25J 15/0616
USPC 414/800; 294/24

(57) ABSTRACT

An end effector (20, 20′) for simultaneously transferring a batch of substrates (202). The end effector (20, 20′) includes a set of juxtaposed substrate grippers (22, 22′) having a pitch between pairs of grippers (22, 22″) that does not exceed six (6.00) mm. Each gripper (22, 22′) has a contact surface (54, 54′) against which a substrate (202) becomes clamped upon injecting a gaseous jet into an open groove (56A, 56B, 56′) formed into the contact surface (54, 54′). Due to the close spacing between immediately adjacent pairs of substrate grippers (22, 22′), the open groove (56A, 56B, 56′) must be very shallow. The open groove (56A, 56B, 56′) can be characterized by having a groove depth into the contact surface (54, 54′) that is between two (2 .00) mm and two and four tenths (2.40) mm. Alternatively, the open groove (56A, 56B, 56′) can be characterized by having a groove width at the contact surface (54, 54′) that is at least three (3) times larger than a groove depth into the contact surface of the substrate gripper.

### TECHNICAL FIELD

The present disclosure relates generally to the technical field of semiconductor processing and, more particularly, to semiconductor wafer/substrate handling.

### BACKGROUND ART

Certain semiconductor wafer processing operations require loading a number of disk-shaped silicon wafers into a process carrier in a particular orientation. Examples of such processes are “wet bench” processing and horizontal diffusion furnace processing. Typically, an integrated circuit (“IC”) fabrication tool processes between 100 wafers to a maximum of 500 wafers per hour. Consequently, a majority of IC fabrication tools employ single substrate transfer. In comparison, silicon solar cell fabrication requires a minimum processing capability of 1600 wafers per hour. In fact, many solar cell fabrication tools require transferring 3000 wafers per hour. Consequently, solar cell fabrication demands mass-transfer of batches of semiconductor substrates.

In general preparing wafers for a process requires:
1. removing the wafers from a cassette used for transporting a batch of wafers;
2. perhaps reorienting the wafers; and
3. depositing the wafers into a process carrier.
   In a high volume production environment that use manual substrate handling breakage rates as high as 2% have been observed. Such a high substrate breakage rate results in significant economic loss. In addition, manually handling substrates produces contact particles or contaminations on the substrate surfaces that further reduce the performance or yield of the final products. To prevent contaminating silicon wafers during transfer and to reduce breakage, such operations are performed automatically by a machine without human intervention in the process.

An automated substrate transfer device must exhibit the following characteristics.
1. Possess an extremely compact design allowing multiple substrates separated spaced closely together (as when substrates are held in a cassette) to be handled in a batch for high throughput production.
2. Be able to maintain substrate positions when the substrate-holder move.
3. Exhibit a lesser long term average breakage rate compared with manual substrate handling.
4. Exhibit high reliability and fully automated operation without operator assistance.

Techniques employed by semiconductor substrate holders or grippers used for transferring semiconductor substrates can be classified into the following four (4) categories.
1. Conventional mechanical holders that grip substrates around their edges using three or four moveable fingers
2. Electro-magnetic grippers that hold substrates by electro-magnetic forces
3. Pneumatic devices, primarily non-contacting, that employ the Bernoulli effect or a venturi to create a “push-pull” suction
4. Direct vacuum-port suction cups or fingers
   A semiconductor substrate holder or gripper is not constrained to use only one of the preceding techniques, but can, in fact, use a combination of two (2) or more of them.

Mechanical grippers (hook and lift) require that substrates be positioned precisely with respect to the grippers to avoid physical contact that might damage substrates at points of contact. Since gravity holds the substrate on the gripper, the substrate cannot be transported freely at any arbitrary orientation. In addition, such mechanical grippers cannot be easily implemented for simultaneous mass-transfer of many substrates.

Electro-magnetic chucks exhibit a complicated design and large physical size. Consequently, electro-magnetic chucks are used primarily for handling a single substrate. For the preceding reasons electro-magnetic chucks are unsuitable for mass-transfer of many substrates simultaneously.

In general, most Bernoulli type substrate-holders exhibit not only large size, but also an inability to clamp substrates firmly against a holding surface. The inability of Bernoulli type substrate-holders to clamp substrates firmly against their holding surface means that most such grippers are non-contact holders.

Substrate-holders employing a direct suction external vacuum source or generator are used most commonly for transferring thin substrates singly, or in a multiple substrate batch. However, assuring reliable suction force requires that the substrate seal all of the substrate-holder's vacuum ports to obtain a desired holding force. A missing, broken or even chipped substrate may cause vacuum to leak from an uncovered port or ports on the substrate-holder. An open port or ports on the substrate-holder markedly reduces the holder's holding force and correspondingly the suction force available at the substrate-holder's other vacuum ports. The lower vacuum that occurs under such circumstances significantly increases the possibility that a substrate might fall when the substrate-holder moves. This particular problem exhibited by direct vacuum suction substrate-holders can be addressed by using an independent vacuum source or generator for each vacuum port to eliminate any holding force reduction due to an uncovered port or ports. Consequently, solving this difficulty with direct vacuum suction substrate-holders increases vacuum ducting system complexity proportional to the number of substrates that need to be handled in each batch, and correspondingly the holder's cost.

Thin semiconductor wafers and solar cell substrates typically have a thickness between 100 μm to 200 μm (microns), i.e. 0.1 to 0.2 mm. The spacing (pitch) between immediately adjacent wafers and solar cell substrates either in a cassette or in a process carrier is typically around 4˜5 mm. Typically, there exists about a 4.75 mm gap between immediately adjacent wafers in a solar cell cassette or process carrier. Such close spacing between immediately adjacent wafers and solar cell substrates makes transferring them into or out of a cassette difficult. Simultaneously exchanging all wafers in a mass-transfer between such a solar cell process carrier and a cassette limits the thickness of a substrate holder or gripper to something significantly less than 4.75 mm, for example to a thickness of approximately 2.4 mm, i.e. less than 0.1 inch.

One embodiment of a “Pick-up Head Utilizing Aspirated Air Flow” described in U.S. Pat. No. 4,474,397 (“the '397 patent”) and depicted in that patent's FIGS. 5 and 6A-6D employs what can be called an elongated slot, channel, trench or trough formed into a solid body. The U-shaped elongated slot, channel, trench or trough is open both:
1. along its length at the body's end wall; and
2. also at one end of the slot, channel, trench or trough.
   An orifice pierces the end of the slot, channel, trench or trough furthest from its open end and receives a supply of a pressurized gas such as compressed air. This configuration for the disclosed pick-up head establishes a compressed air flow condition that is confined along the length of the U-shaped slot, channel, trench or trough on three sides, i.e. by two (2) facing side walls of the slot, channel, trench or trough and by a floor that extends between the side walls. This configuration for the disclosed pick-up head focuses an aspiration effect into the region of the slot, channel, trench or trough.

The '397 patent specifically describes a U-shaped slot, channel, trench or trough that is approximately:
1. 0.5 inches long from where compressed gas enters the slot, channel, trench or trough to its open end furthest from the entry orifice:
2. 0.25 inches deep from the slot, channel, trench or trough opening along the body's end wall to its floor; and
3. 0.03125 inches wide between two (2) facing side walls of the slot, channel, trench or trough.
   That is, the disclosed slot, channel, trench or trough has:
1. a length to depth ratio of 2:1; and
2. a depth to width ratio of 8:1, i.e. is narrow and tall.
   The feed groove through which compressed gas enters each slot, channel, trench or trough depicted in FIGS. 6A-6D:

1. is located at the floor of the slot, channel, trench or trough furthest from its opening at the body's end wall; and
2. as disclosed in the '397 patent is “approximately 0.015625 inches square and approximately 0.15625 inches long” i.e has a length to width/depth ratio of 10:1.
   The '397 patent states that “[i]t has been found that a long narrow groove passage defining the slots is much more effective than a short plate orifice.”

The flow condition of gas injected from the orifice into the slot, channel, trench or trough disclosed in the '397 patent, as depicted in FIGS. 6A-6D, is confined thereto by the two (2) facing side walls and the floor thereof. The injected gas characteristically entrains atmosphere adjacent to the body's end wall to thereby:
1. suck the adjacent atmosphere into the slot, channel, trench or trough; and
2. ultimately discharge the entrained atmosphere from the open end of the slot, channel, trench or trough furthest from the orifice.
   As a consequence of entraining atmosphere adjacent to the body's end wall, when a reasonably flat surface, whether a rigid wafer or a flexible green sheet, is placed in proximity of the pick-up head's end wall, it will be rapidly drawn to that end wall to be held there. The pick-up head's holding and/or lifting capability is a function of the slot configuration and dimension, slot pattern as well as the compressed air flow rate. Although the pick-up head depicted in the '397 patent is straight, the patent states that the slot, channel, trench or trough may be curved or sinuous. The '397 patent reports that one principal advantage of the pick-up head is that in comparison with a pick-up head that uses vacuum the aspirated air flow characteristics produce a larger integrated suction effect over a larger region of the head. Thus, a sheet of material is more effectively attracted to the pick-up head's end wall along the length of the slot, an important characteristic for picking up flexible easily damaged green sheets. Moreover, because pressurized jets are used to create suction, line clogging tendencies are minimized. The '397 patent states that in operation, the device is thoroughly insensitive to variations in flow conditions.

### DISCLOSURE

An object of the present disclosure is to provide an improved end effector for simultaneously transferring a batch of substrates out of or into a cassette or process carrier.

Another object of the present disclosure is to provide an improved substrate gripper particularly adapted for inclusion in an end effector that simultaneously transfers a batch of substrates out of or into a cassette or process carrier.

Another object of the present disclosure is to provide a compact substrate gripper particularly adapted for inclusion in an end effector that simultaneously transfers a batch of substrates out of or into a cassette or process carrier.

Another object of the present disclosure is to provide improved end effector having a plurality of substrate grippers each of which operates independently of the end effector's other substrate grippers holding or not holding a substrate.

Another object of the present disclosure is to provide an improved end effector for simultaneously picking-up a batch of substrates from a cassette or process carrier and moving the substrates through 3-D space at any desired angle.

Another object of the present disclosure is to provide an improved end effector for simultaneously picking-up a batch of substrates from a cassette or process carrier and moving the substrates through 3-D space while maintaining the substrates position within the end effector.

Yet another object of the present disclosure is to provide an improved end effector which is simple.

Yet another object of the present disclosure is to provide an improved end effector that reliably carries an entire batch of substrates that is being transferred out of or into a cassette or process carrier.

Yet another object of the present disclosure is to provide an improved end effector which is durable.

Yet another object of the present disclosure is to provide an improved end effector whose operating condition is easily assessed.

Yet another object of the present disclosure is to provide an improved end effector that is easy to manufacture.

Yet another object of the present disclosure is to provide an improved end effector that is easy to maintain.

Briefly, disclosed herein is an improved end effector for simultaneously transferring a batch of substrates out of or into a cassette or process carrier. The end effector includes a plurality of juxtaposed substrate grippers that have a pitch between immediately adjacent pairs of substrate grippers that does not exceed six (6.00) mm. Each substrate gripper has a contact surface against which a substrate becomes clamped upon injecting a gaseous jet into an open groove formed into the contact surface of the substrate gripper. Due to the close spacing between immediately adjacent pairs of substrate grippers, the open groove must be very shallow. The open groove can be characterized by having a groove depth into the contact surface of the substrate gripper that is between two (2.00) mm and two and four-tenths (2.40) mm. Alternatively, the open groove can be characterized by having a groove width at the contact surface of the substrate gripper that is at least three (3) times larger than a groove depth into the contact surface of the substrate gripper.

These and other features, objects and advantages will be understood or apparent to those of ordinary skill in the art from the following detailed description of the preferred embodiment as illustrated in the various drawing figures.

### BRIEF DESCRIPTION OF DRAWINGS

FIG. 1 is a perspective view of a semiconductor substrate mass-transfer end effector in accordance with the present disclosure;

FIG. 2 is an alternative perspective view of the mass-transfer end effector taken along the line 2-2 in FIG. 1 with an end-plate removed therefrom thereby revealing one surface of one of a number of semiconductor suction finger substrate grippers included in the end effector;

FIG. 3 is yet another alternative perspective view of the mass-transfer end effector taken along the line 3-3 in FIG. 1 with the end-plate removed therefrom thereby showing one of a number of semiconductor suction finger substrate grippers included in the end effector;

FIG. 4 is a perspective view illustrating stacking together of a number of semiconductor suction finger substrate grippers included in the semiconductor substrate mass-transfer end effector depicted in FIGS. 1-3;

FIG. 5 is a diagrammatic, perspective view of an alternative embodiment suction finger substrate gripper having a contact surface of the gripper's suction finger blade juxtaposed with a semiconductor substrate depicted in dashed lines;

FIG. 6 is a cross-sectional view of the alternative embodiment suction finger substrate gripper taken along the line 6-6 of FIG. 5 when the suction finger is mated with a suction finger base included in an alternative embodiment end effector; and

FIG. 7, is a cross-sectional view of an end effector that includes the suction-finger base that is partially depicted in FIG. 6 and which includes several of the alternative embodiment suction finger substrate grippers depicted in FIGS. 5 and 6.

### BEST MODE FOR CARRYING OUT THE DISCLOSURE

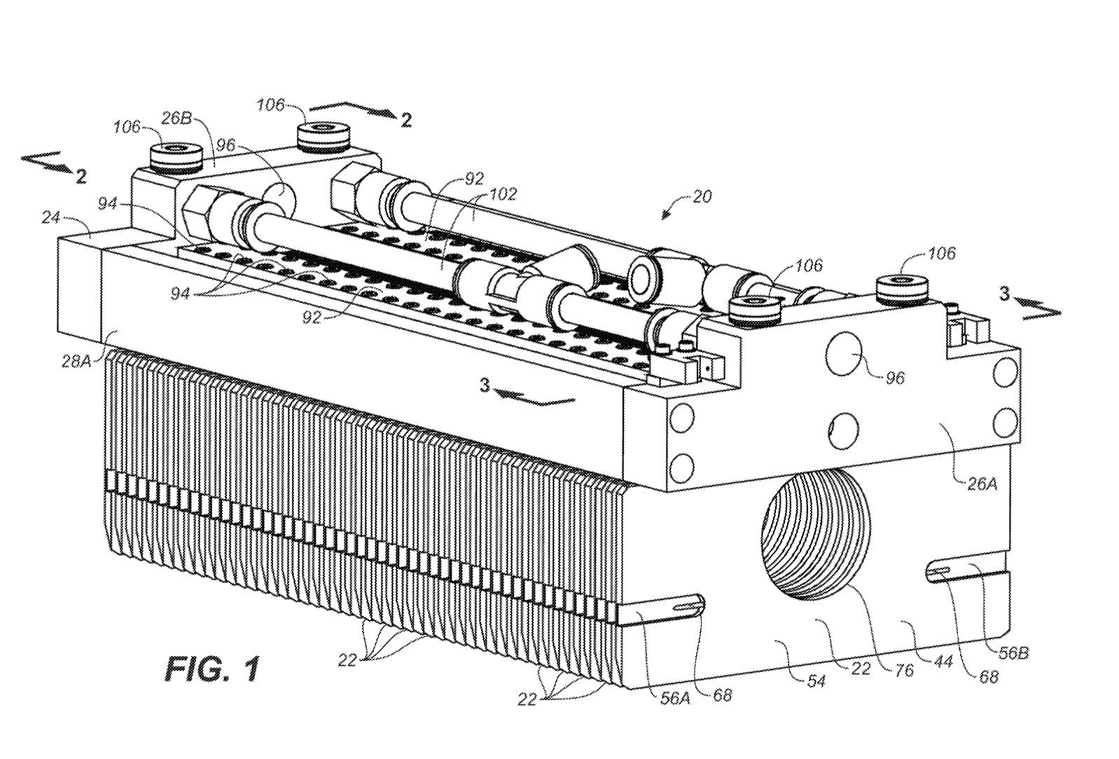

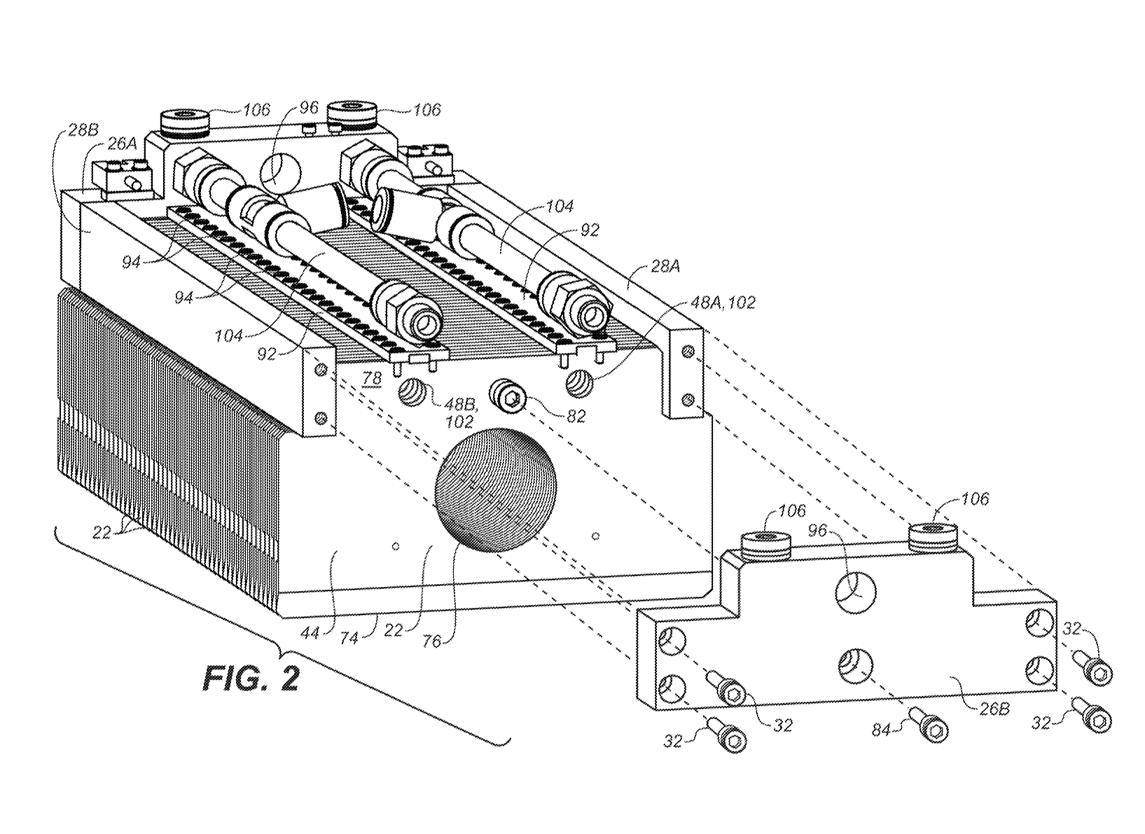

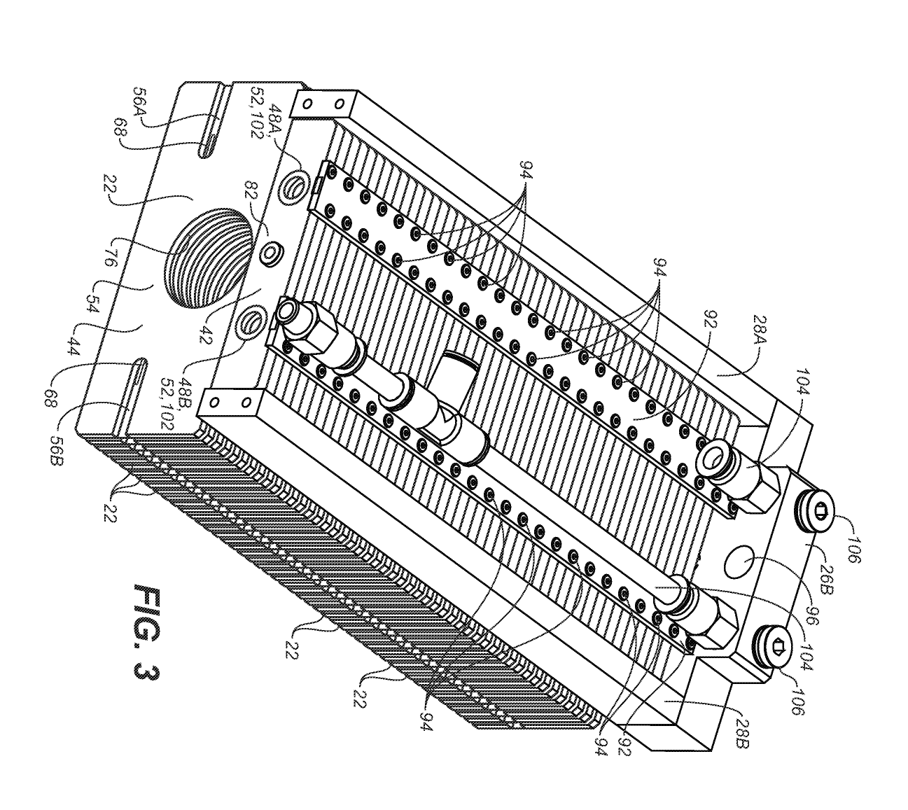

FIG. 1 depicts a presently preferred embodiment of a mass-transfer effector identified by the general reference number 20 that is adapted for simultaneously transferring a batch of thin semiconductor substrates. The end effector 20 includes a number of juxtaposed suction-finger substrate grippers 22 the upper portion of which are surrounded by and supported by a rectangularly-shaped end effector frame 24. The end effector frame 24 includes a pair of end plates 26A and 26B that are located at opposite ends of the end effector frame 24, and are oriented parallel to the substrate grippers 22. A pair of side rails 28A and 28B, better illustrated in FIGS. 2 and 3, extend between the end plates 26A and 26B at opposite ends thereof. As best illustrated in FIG. 2, a pair of fasteners 32 secure one end of each of the end plates 26A and 26B to an immediately adjacent end of each of the side rails 28A and 28B to thereby establish the end effector frame 24.

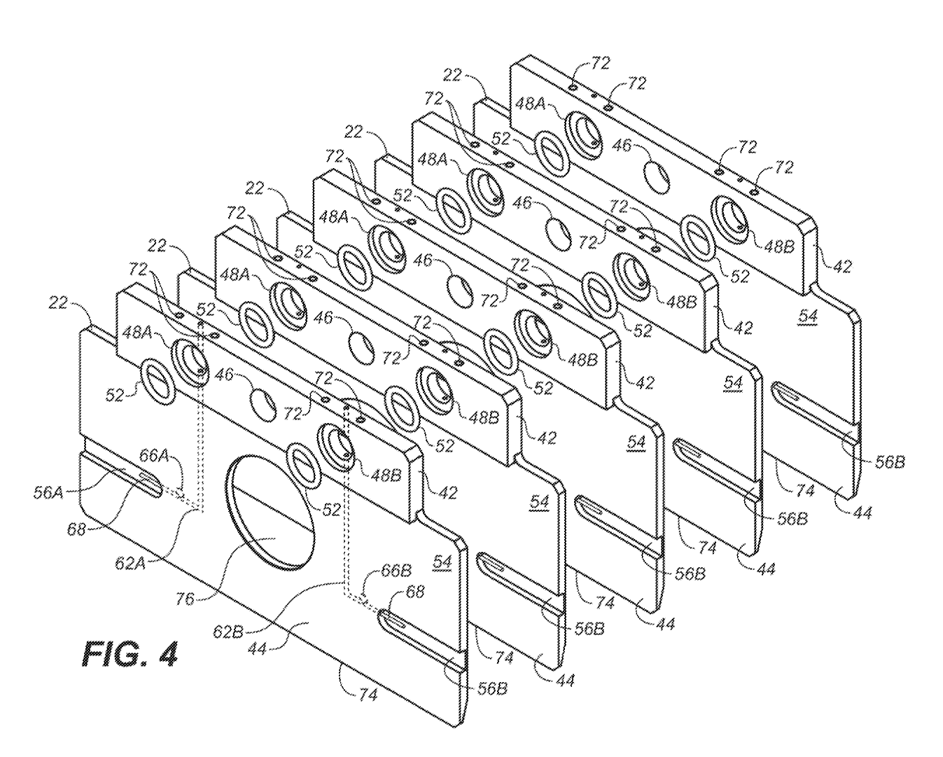

FIG. 4 illustrates assembly of several substrate grippers 22 included in the end effector 20 depicted in FIGS. 1-3. Each of the substrate grippers 22 has a thicker header section 42 beneath which depends a thinner and wider suction-finger blade 44. Each header section 42 includes a centered mounting hole 46, and a pair of gas supply holes 48A and 48B respectively located symmetrically on opposite sides of the mounting hole 46. Edges of the gas supply holes 48A and 48B both on front and back surfaces of each header section 42 are beveled. Beveling the gas supply holes 48A and 48B creates a cavity for receiving one side of an O-ring 52 that fits between each immediately adjacent pair of gas supply holes 48A and gas supply holes 48B. Each pair of O-rings 52 seals between each immediately adjacent pair of gas supply holes 48A and gas supply holes 48B.

Each suction-finger blade 44 of each substrate gripper 22 includes a substantially planar contact surface 54 that extends downward from the header section 42 to a lower edge of the suction-finger blade 44. A pair of open grooves 56A and 56B are formed into the contact surface 54 of each suction-finger blade 44. In the particular embodiment of the substrate gripper 22 depicted in FIG. 4, each pair of open grooves 56A and 56B are colinear and directed away from each other extending to and remaining open along opposite edges of the suction-finger blade 44.

Each of the substrate grippers 22 also includes a pair of L-shaped gas passages 62A and 62B only one pair of which appears in dashed lines in the illustration of FIG. 4. A vertical portion of each gas passages 62A and 62B is bored down through the header section 42 and one of either of the gas supply holes 48A or 48B, and then continues down into the suction-finger blade 44 extending to a depth that is below the middle of the open grooves 56A and 56B. A lateral portion of each of the gas passages 62A and 62B is bored across the suction-finger blade 44 at the middle of the open grooves 56A and 56B to intersect respectively the vertical portion of the gas passages 62A or 62B. Before the substrate grippers 22 are assembled into the end effector 20, segments of the gas passages 62A and 62B in each of the header sections 42 above the gas supply holes 48A and 48B are sealed so pressurized gas present within the gas supply holes 48A or 48B can only flow out of the substrate gripper 22 via the gas passages 62A or 62B.

A pair of blind holes 66A and 66B are bored into the contact surface 54 of each suction-finger blade 44 respectively about the middle of the lateral portion of each of the gas passages 62A and 62B. Each of the blind holes 66A and 66B penetrates to a depth so it intersects the lateral portion of each of the gas passages 62A and 62B. The blind holes 66A and 66B permit visually observing when one end of a compression fit, hollow air needle 68 has been pressed sufficiently far into the lateral portion of each of the gas passages 62A and 62B. As depicted in FIG. 4, an end of each air needle 68 furthest from the blind holes 66A and 66B projects out of the end of the lateral portion of each of the gas passages 62A or 62B into the open grooves 56A or 56B formed into the suction-finger blade 44 of each substrate gripper 22. Similar to the segments of the gas passages 62A and 62B in each of the header sections 42 above the gas supply holes 48A and 48B, before the substrate grippers 22 are assembled into the end effector 20 the blind holes 66A and 66B of each suction-finger blade 44 are sealed.

A pair of threaded holes 72 extend a short distance into each header section 42 on opposite sides of the vertical portion of each gas passages 62A and 62B above the gas supply holes 48A and 48B. As described in greater detail below, the threaded holes 72 receive screws when the substrate grippers 22 are assembled into the end effector 20. As best illustrated in FIG. 2, a lower edge 74 of the suction-finger blade 44 furthest from the header section 42 is tapered to facilitate inserting the contact surface 54 thereof between immediately adjacent pairs of semiconductor substrates.

Finally, a large, centrally located hole 76 pierces the suction-finger blade 44 of each substrate gripper 22. The hole 76 serves no function in the assembled end effector 20. Rather the hole 76 is used for clamping the substrate gripper 22 during its fabrication.

A presently preferred embodiment for the substrate gripper 22 has a suction-finger blade 44 that is one-hundred thirty (130) mm wide with a height for the combined header section 42 plus the suction-finger blade 44 of seventy-five (75) mm. For this particular embodiment of the substrate gripper 22, as depicted in FIG. 2 a surface 78 of the suction-finger blade 44 furthest from the contact surface 54 and one side of the header section 42 are coplanar. Above the tapered lower edge, the suction-finger blade 44 has a thickness of two and four-tenths (2.40) mm and the header section 42 has a thickness of four and seventy-six-hundredths (4.76) mm. Due to differing thicknesses of the header section 42 and the suction-finger blade 44, the header section 42 extends outward beyond and above the contact surface 54 of the suction-finger blade 44.

For transferring substrates into or out of a process carrier, the pitch between immediately adjacent substrate grippers 22 does not exceed six (6.00) mm. The open grooves 56A and 56B have a depth into the contact surface 54 of the suction-finger blade 44 between one and five-tenths (1.50) mm and two and four-tenths (2.40) mm, and have a width at the contact surface 54 of the suction-finger blade 44 that is at least three (3) times larger than the depth into the contact surface 54 of the suction-finger blade 44. For the presently preferred embodiment, each of the open grooves 56A and 56B extends one and eight-tenths (1.80) mm into the suction-finger blade 44, is six (6.00) mm wide parallel to the contact surface 54, and extends twenty-five (25.00) mm parallel to the contact surface 54. The lateral portion of each of the gas passages 62A and 62B is eight-tenths (0.8) mm in diameter and is centered in the thickness of the suction-finger blade 44. The center of the vertical portion of each gas passages 62A and 62B is coplanar with the center of the lateral portion of each of the gas passages 62A and 62B, and the vertical portion of each gas passages 62A and 62B has a diameter of one (1.00) mm.

Referring back to FIGS. 2 and 3, when incorporated into the end effector 20 the mounting holes 46 that pierce the header sections 42 of the substrate grippers 22 encircle a rod 82 that extends between the end plates 26A and 26B of the end effector frame 24. As illustrated in FIG. 2, a pair of fasteners 84, only one of which appears in FIG. 2, respectively pass through each of the end plates 26A and 26B to fix the rod 82 therebetween.

As depicted in FIGS. 1-3, the end effector 20 also includes a pair of thin bars 92 that extend the length of the end effector 20 between the end plates 26A and 26B. In addition to hanging from the rod 82, threaded holes 72 located in the header sections 42 of the substrate grippers 22 receive and engage fasteners 94 that pass through bars 92. Fastening the substrate grippers 22 to the pair bars 92 unites the respective sides of all the header sections 42 and ensures uniform spacing of the substrate gripper 22 throughout the length of the end effector 20.

Finally, holes 96 respectively pass through each of the end plates 26A and 26B for securing the end effector 20 to a device that is capable of moving the end effector 20 in relationship to some type of substrate processing device. One example of a device that might be used for moving the end effector 20 is the SCARA arm disclosed in U.S. Pat. No. 6,494,666.

Assembled as illustrated in FIGS. 1-4, the O-rings 52 and the gas supply holes 48A and 48B collectively establish a pair of sealed compressed gas passages 102 that respectively extend along both sides of the header sections 42 between the end plates 26A and 26B. Each of the end plates 26A and 26B includes a pair of U-shaped compressed gas passages, not illustrated in any of the FIGS., that couple between the compressed gas passages 102 and a pair of compressed gas supply tubes 104 that span between the end plates 26A and 26B. A pair of plugs 106, respectively fixed into each of the end plates 26A and 26B, close holes formed thereinto during fabrication of the U-shaped compressed gas passages. Connected in this way, the compressed gas supply tubes 104, the end plates 26A and 26B and the compressed gas passages 102 establish a sealed plenum through which compressed gas may be supplied via the gas passages 62A and 62B to all of the air needles 68 included in the end effector 20.

For the embodiment of the end effector 20 depicted in FIGS. 1-4, the air needles 68 preferably have an outside diameter of seven-tenths (0.70) mm, and an inside diameter of four-tenths (0.40) mm. The air needles 68 are preferably sixteen (16.00) mm long, and project approximately five to six (5.00-6.00) mm into the open grooves 56A and 56B. Supplying compressed air to the compressed gas passages 102 at a pressure between 0.45 Megapascal (“MPa”) and 0.6 MPa, preferably 0.5 MPa, injects a jet of gas from the air needles 68 into the open grooves 56A and 56B formed into the contact surfaces 54 of all the substrate grippers 22 included in the end effector 20. As explained in greater detail below, due to the Bernoulli effect injecting jets of gas into each pair of gas passages 62A and 62B applies a force to a substrate adjacent to the suction-finger blade 44 for clamping the substrate thereto.

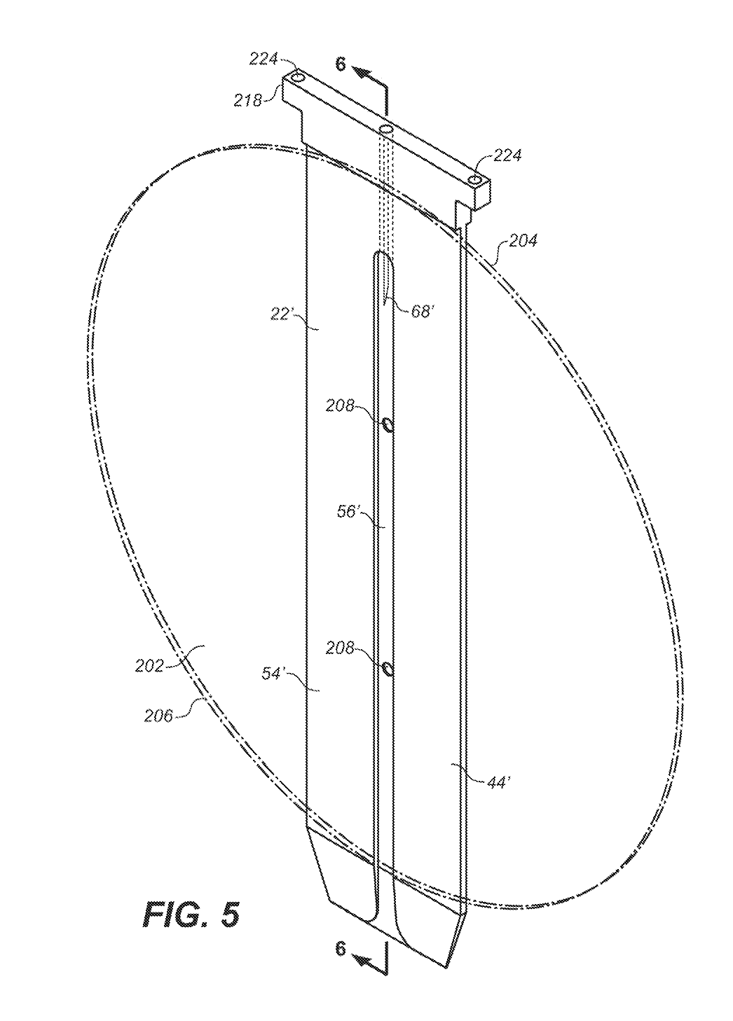

FIGS. 5-7 illustrate an alternative embodiment substrate gripper and substrate-holding end effector in accordance with the present disclosure. Those elements depicted in FIGS. 5-7 that are common to the end effector 20 illustrated in FIG. 1-4 carry the same reference numeral distinguished by a prime (“′”) designation.

FIG. 5 depicts diagrammatically an alternative embodiment substrate gripper 22′ associated with a thin substrate 202 depicted with dashed lines. In the illustration of FIG. 5 an abutting surface 204 of the substrate 202 is juxtaposed with the contact surface 54′ of the suction-finger blade 44′. The substrate 202 also includes a non-contact surface 206 that is furthest from the contact surface 541. An upper end of the alternative embodiment suction-finger substrate gripper 22′ receives a compression fit air needle 68′. Analogously to the hole 76 depicted in FIGS. 1-4 that pierces the suction-finger blade 44′ of the substrate gripper 22′, a pair of holes 208 piercing the suction-finger blade 44′ at the bottom of an open groove 56′ are used for securing the substrate gripper 22′ during its fabrication

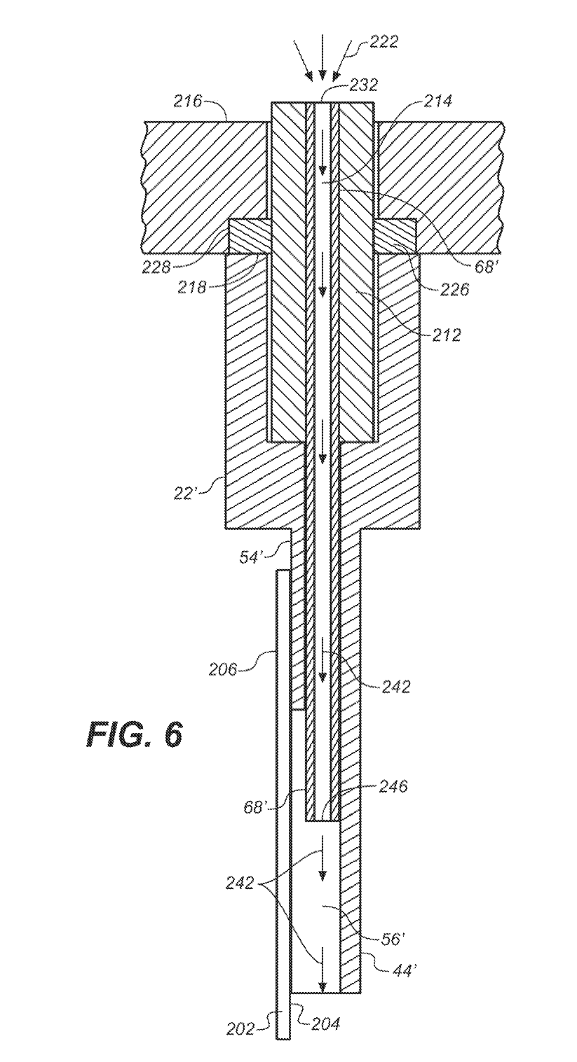

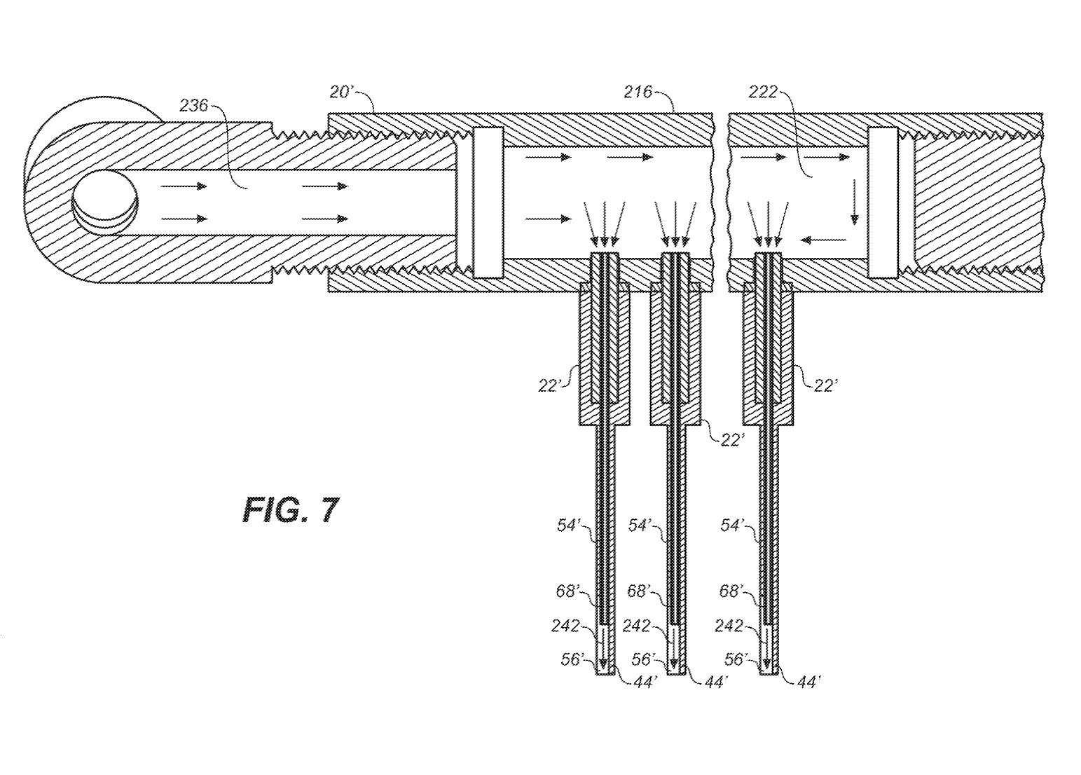

In a more detailed, cross-sectional depiction of the alternative embodiment substrate gripper 22′ appearing in FIG. 6, the substrate gripper 22′ includes a cylindrical-shaped air needle sleeve 212 that receives an upper end of the longer, cylindrically-shaped hollow air needle 68′ that encircles an air tunnel 214. The substrate gripper 22′ is secured to a suction-finger base 216 of the alternative embodiment end effector. An upper end of the air needle 68′ extends above a top shoulder 218 of the suction-finger blade 44′ and into a compressed air chamber 222, indicated by arrows in FIG. 6. As illustrated in FIG. 7, the compressed air chamber 222 is located above the substrate gripper 22′ and within the suction-finger base 216 of the alternative embodiment end effector 20′. The substrate gripper 22′ includes two (2) mounting holes 224 depicted in FIG. 5 that pierce the top shoulder 218 thereof. Each of the mounting holes 224 respectively receives a mounting screw for securing the substrate gripper 22′ to the suction-finger base 216. Where the substrate gripper 22′ abuts the suction-finger base 216, an O-ring 226 depicted in FIG. 6 encircles the air needle sleeve 212 of the substrate gripper 22′ and is received within a groove 228 formed into the suction-finger base 216.

Configured as described above, the O-ring 226 provides an air tight assembly that prevents air from leaking out from the compressed air chamber 222 at the interface between the substrate gripper 22′ and the suction-finger base 216. However, compressed air within the compressed air chamber 222 freely enters the air tunnel 214 within the air needle 68′ at an air inlet 232 thereof that is located within the compressed air chamber 222. The air needle sleeve 212 and the O-ring 226 assembled between the suction-finger blade 44′ and the suction-finger base 216 provide air tight assembly thereby preventing any air from leaking out from the compressed air chamber 222 at the junction with the substrate gripper 22′. Accordingly, air flows out of the compressed air chamber 222 only through air inlets 232 of air needle 68′ thereby ensuring that there will be no extraneous air flow(s) from the compressed air chamber 222 that might adversely affect performance of the end effector 20′.

In operation, a conventional air control unit, not illustrated in any of the FIGS., receives a supply of compressed air from any conventional compressed air source. As will be readily understood by those skilled in the relevant art, the air control unit may include an air pressure regulator, an air filter, air flow control solenoid valves, and an electronic control. The air control unit merely receives a supply of compressed air from the conventional compressed air source, and provides a controlled source of compressed air to an air source chamber 236 depicted in FIG. 7 that is included in the end effector 20′.

In operation, compressed flows from the air source chamber via the compressed air chamber 222 into the air tunnel 214 of each substrate gripper 22′ at the air inlet 232 thereof. In comparison with the compressed air chamber 222, the air tunnel 214 has a small diameter through which compressed air flows. Configured in this way, compressed air flowing from the compressed air chamber accelerates inside the air tunnel 214 to establish a high-speed air flow 242 indicated by arrows in FIGS. 6 and 7. The high-speed air flow 242 emerges from the air needle 68′ at an air outlet 246 depicted in FIG. 6 that is located at:
1. an end of the air needle 68′ furthest from the air source chamber 236; and
2. an inlet to the open groove 56′, that is recessed into the suction-finger blade 44′, receives the air flow from the air needle 68′.
   Injected into the open groove 56′ in this way, in comparison with atmosphere surrounding the lower end of the suction-finger blade 44′ the high-speed air flow emerging from the air outlet 246 creates an area of lower pressure air around the open grooves 56′. The air pressure difference created by injecting high-speed air flow into the open groove 56′ draws a thin substrate 202 depicted in FIGS. 5 and 6 toward the contact surface 54′ of the suction-finger blade 44′ thereby clamping the substrate 202 to the substrate gripper 22′.

The physical principle underlying operation of the substrate gripper 22′ for clamping the thin substrate 202 to the contact surface 54′ of the suction-finger blade 44′ is the Bernoulli principle in which a high-speed air flow establishes a lower pressure area in comparison with surrounding atmosphere. More specifically:
1. compressed air that enters the end effector 20′ at the air control unit flows into the air source chamber 236. The air source chamber 236 provides stable air supply to the compressed air chamber 222 to establish a uniform pressure throughout the entire length of the compressed air chamber 222 inside the suction-finger base 216.
2. The air needle sleeve 212 and the seal ring between the suction-finger blade 44′ and the suction-finger base 216 provide an air tight assembly allowing air to exit from the compressed air chamber 222 only through the air inlet 232 of air needles 68′.
3. The narrow air path within the air tunnel 214 creates high-speed air flow 242 that is emitted from the air outlet 246 into a pocket created by the open groove 56′.
4. Constrained by side walls of the open groove 56′, the high-speed air flow 242 flows through the inside surface of open groove 56′ on the suction-finger blade 44′ to create lower air pressure for attracting a thin substrate 202 adjacent to the suction-finger blade 44′.
5. After the substrate 202 is drawn toward the contact surface 54′ of the suction-finger blade 44′, high-speed air continues to flow through the open groove 56′ and exit from the bottom of the suction-finger blade 44′ uninterruptedly.
6. The pressure difference between that inside the open groove 56′ and atmosphere pressing against a non-contact surface 206 of substrate 202 forces the substrate 202 against the contact surface 54′ of the suction-finger blade 44′.
   In this way the disclosed end effector 20′ achieves the function of holding thin substrate 202 for transfer movements. Since the high-speed air flow 242 flows through each suction-finger blade 44′ independently, force clamping each substrate 202 to each substrate gripper 22′ is unaffected regardless of whether an adjacent substrate gripper 22′ is or is not holding a thin substrate 202. The disclosed end effector 20′, which is easy to manufacture, provides independent and stable performance for batch transfer of a large number of thin substrate 202.

### INDUSTRIAL APPLICABILITY

The end effector 20 or 20′ described above may be used advantageously for simultaneously transferring a batch of substrates 202 between a cassette and a process carrier. Such a mass-transfer of a batch of substrates 202 between a cassette and a process carrier or conversely begins with juxtaposing contact surfaces 54, 54′ of a plurality of substrate grippers 22, 22′ included in an end effector 20, 20′ individually with a number of substrates 202 disposed either in the cassette or in the process carrier. After the plurality of substrate grippers 22, 22′ are juxtaposed with the substrates 202, gaseous jets are injected into the open grooves 56A and 56B, 56′ of the contact surfaces 54, 54′ of the plurality of substrate grippers 22, 22′ whereby the substrates 202 become clamped to an adjacent contact surface 54, 54′. After the substrates 202 become clamped to adjacent contact surfaces 54, 54′ while continuing to inject the gaseous jets into open grooves 56A and 56B, 56′, the end effector 20, 20′ together with the substrates 202 clamped to the contact surfaces 54, 54′ of the substrate grippers 22, 22′ is moved away from the cassette or process carrier thereby removing the substrates 202 therefrom. After the substrates 202 have been removed from the cassette or process carrier, the end effector 20, 20′ together with the substrates 202 clamped to the contact surfaces 54, 54′is positioned adjacent to the process carrier or cassette. After the end effector 20, 20′ together with the substrates 202 clamped to the contact surfaces 54, 54′ are adjacent to the process carrier, the substrates 202 clamped to the contact surfaces 54, 54′ of the substrate grippers 22, 22′ are aligned with the process carrier or cassette whereby the substrates 202 become receivable thereinto. After the substrates 202 clamped to the contact surfaces 54, 54′ are aligned with the process carrier or cassette, the end effector 20, 20′ together with the substrates 202 clamped to the contact surfaces 54, 54′ moves toward the process carrier or cassette thereby depositing the substrates 202 thereinto. After the substrates 202 have been deposited into the process carrier or cassette, injection of the gaseous jets into open grooves 56A and 56B, 56′ is terminated whereby the substrate grippers 22, 22′ release the substrates 202. Finally, the end effector 20, 20′ together with the substrate grippers 22, 22′ are moved away from the substrates 202 now disposed in the process carrier or cassette.

The difference in air pressure that produces the substrate holding forces at each substrate gripper 22, 22′ depends on the high-speed air flow 242 inside the open grooves 56A and 56B or 56′. The high-speed air flow 242 can be controlled by regulating the air pressure inside the compressed gas supply tubes 104 or compressed air chamber 222 with the air control unit. An air pressure monitoring device inside the air control unit or inside the compressed gas supply tubes 104 or compressed air chamber 222 can be used to determine the operating condition of the substrate grippers 22, 22′. Measuring an air pressure inside the air control unit or inside the compressed gas supply tubes 104 or compressed air chamber 222 that is below a preestablished threshold will inhibit a motion control unit such as the SCARA arm disclosed in U.S. Pat. No. 6,494,666 from moving the end effector 20, 20′ thereby avoiding damage to substrates 202 clamped to the suction-finger blade 44, 44′ of substrate grippers 22. 22′.

Experimental results demonstrate an air needle 68′ having a 0.5 mm diameter and a length of 38 mm for the air tunnel 214 that receives air at the air inlet 232 within the compressed air chamber 222 at a pressure 0.4 MPa, and that emits air along the open groove 56′ that is 5 mm wide and 1.1 mm deep produces sufficient force to grip a substrate 202 that weights 12 grams. Preferably, the contact surface 54′ of the alternative embodiment suction-finger blade 44′ has a length that is at least equal to if not longer than the length of the abutting surface 204 of the substrate 202 that is juxtaposed with the contact surface 54′. A length for the contact surface 54′ that equals or exceeds the length of the abutting surface of the substrate 202 reduces the possibility that air discharged from the lower end of the open groove 56′ might induce vibration of the substrate 202.

In summary, the disclosed end effector 20, 20′ is extremely compact thereby allowing a batch of substrates 202 spaced closely together as when substrates 202 are held in a cassette or process carrier to be picked-up and moved through 3-D space at any desired angle. The disclosed end effector 20, 20′ maintains positions of substrate 202 firmly on the suction-finger blade 44, 44′ while they are moved. The disclosed end effector 20, 20′ is extremely reliable and no mechanical forces besides the air pressure and holding forces necessary to grip and hold substrate 202 are present. By combining the disclosed end effector 20, 20′ with conventional logic control and motion devices, operation of the disclosed end effector 20, 20′ may be fully automated for transferring batches of thin substrate 202 without operator assistance.

Although the present invention has been described in terms of the presently preferred embodiment, it is to be understood that such disclosure is purely illustrative and is not to be interpreted as limiting. For example, a substrate gripper 22, 22′ in accordance with the present disclosure may include only one (1) open groove 56′, two (2) open grooves 56A and 56B, or more. Similarly, the open grooves 56A or 56B or 56′ need not be oriented only laterally or vertically, but may have any arbitrary orientation. Consequently, without departing from the spirit and scope of the disclosure, various alterations, modifications, and/or alternative applications of the disclosure will, no doubt, be suggested to those skilled in the art after having read the preceding disclosure. Accordingly, it is intended that the following claims be interpreted as encompassing all alterations, modifications, or alternative applications as fall within the true spirit and scope of the disclosure.

1. An end effector adapted for simultaneously transferring a batch of substrates, the end effector comprising a plurality of juxtaposed substrate grippers having a pitch between immediately adjacent pairs of substrate grippers that does not exceed six (6.00) mm, each substrate gripper having a contact surface against which a substrate becomes clamped upon injecting a first gaseous jet into a first open groove formed into the contact surface of the substrate gripper, the first open groove having a groove depth into the contact surface of the substrate gripper that is between two (2.00) mm and two and four-tenths (2.40) mm.

2. An end effector adapted for simultaneously transferring a batch of substrates, the end effector comprising a plurality of juxtaposed substrate grippers having a pitch between immediately adjacent pairs of substrate grippers that does not exceed six (6.0) mm, each substrate gripper having a contact surface against which a substrate becomes clamped upon injecting a first gaseous jet into a first open groove formed into the contact surface of the substrate gripper, the first open groove having a groove width at the contact surface of the substrate gripper that is at least three (3) times larger than a groove depth into the contact surface of the substrate gripper.

3. The end effector of claim 1 wherein the substrate is also clamped to the substrate by injecting a second gaseous jet into a second open groove also formed into the contact surface of the substrate gripper.

4. The end effector of claim 3 wherein the second gaseous jet is injected into the second open groove concurrently with injection of the first gaseous jet into the first open groove.

5. The end effector of claim 3 wherein the second gaseous jet injected into the second open groove is directed diametrically away from the first gaseous jet injected into the first open groove.

6. The end effector of claim 3 wherein the gaseous jet is injected via an air needle into an open groove selected from a group consisting of the first open groove and the second open groove.

7. A method for transferring a batch of substrates from a cassette to a process carrier comprising the steps of:
1. juxtaposing contact surfaces of a plurality of substrate grippers, all of which are included in an end effector, individually with a number of substrates disposed in the cassette, the spacing between immediately adjacent pairs of substrate grippers not exceeding six (6.0) mm;
2. injecting gaseous jets into open grooves formed into contact surfaces of the plurality of substrate grippers whereby the substrates become clamped to an adjacent contact surface;
3. while continuing to inject the gaseous jets into open grooves formed into contact surfaces of the plurality of substrate grippers:
a. moving the end effector together with the substrates clamped to the contact surface of the substrate grippers away from the cassette thereby removing the substrates from the cassette;
b. positioning the end effector together with the substrates clamped to the contact surface of the substrate grippers adjacent to the process carrier;
c. aligning the substrates clamped to the contact surface of the substrate grippers with the process carrier whereby the substrates become receivable into the process carrier; and
d. moving the end effector together with the substrates clamped to the contact surface of the substrate grippers toward the process carrier thereby depositing the aligned substrates into the process carrier;
4. terminating the injection of the gaseous jets whereby the substrate grippers release the substrates; and
5. moving the end effector together with the substrate grippers away from the substrates now disposed in the process carrier.

8. A method for transferring a batch of substrates from a process carrier to a cassette comprising the steps of:
1. juxtaposing contact surfaces of a plurality of substrate grippers, all of which are included in an end effector, individually with a number of substrates disposed in the process carrier, the spacing between immediately adjacent pairs of substrate grippers not exceeding six (6.0) mm;
2. injecting gaseous jets into open grooves formed into contact surfaces of the plurality of substrate grippers whereby the substrates become clamped to an adjacent contact surface;
3. while continuing to inject the gaseous jets into open grooves formed into contact surfaces of the plurality of substrate grippers:
a. moving the end effector together with the substrates clamped to the contact surface of the substrate grippers away from the process carrier thereby removing the substrates from the process carrier;
b. positioning the end effector together with the substrates clamped to the contact surface of the substrate grippers adjacent to the cassette;
c. aligning the substrates clamped to the contact surface of the substrate grippers with the cassette whereby the substrates become receivable into the cassette; and
d. moving the end effector together with the substrates clamped to the contact surface of the substrate grippers toward the cassette thereby depositing the aligned substrates into the cassette;
4. terminating the injection of the gaseous jets whereby the substrate grippers release the substrates; and
5. moving the end effector together with the substrate grippers away from the substrates now disposed in the cassette.

9. A substrate gripper comprising a contact surface having an open groove formed thereinto that has groove depth into the contact surface that is between two (2.00) mm and two and four-tenths (2.40) mm, a substrate becoming clamped to the contact surface upon injecting a gaseous jet into the open groove

10. A substrate gripper comprising a contact surface having an open groove formed thereinto that has groove width at the contact surface that is at least three (3) times larger than a groove depth into the contact surface, a substrate becoming clamped to the contact surface upon injecting a gaseous jet into the open groove.

11. The end effector of claim 9 wherein the gaseous jet is injected into the open groove from an air needle.

12. The end effector of claim 2 wherein the substrate is also clamped to the substrate by injecting a second gaseous jet into a second open groove also formed into the contact surface of the substrate gripper.

13. The end effector of claim 12 groove concurrently with injection of the first gaseous jet into the first open groove.

14. The end effector of claim 12 wherein the second gaseous jet injected into the second open groove is directed diametrically away from the first gaseous jet injected into the first open groove.

15. The end effector of claim 12 wherein the gaseous jet is injected via an air needle into an open groove selected from a group consisting of the first open groove and the second open groove.

16. The end effector of claim 10 wherein the gaseous jet is injected into the open groove from an air needle.
